(19) United States
(12) Patent Application Publication
(10) Pub. No.: US 2004/0130992 A1
(43) Pub. Date: Jul. 8, 2004

(54) Data recording apparatus and data recording method

(75) Inventor: Hiroyuki Idobuchi, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/721,790

(22) Filed: Nov. 26, 2003

(30) Foreign Application Priority Data
Nov. 29, 2002 (JP) 2002-347505

(51) Int. Cl. G11B 7/00

(52) U.S. Cl. 369/53.37; 369/59.25

(57) ABSTRACT

A data recording apparatus according to one aspect of this invention comprises a recording/erase unit configured to record or erase target data by irradiating a DVD-RW medium with light beams with different intensities to change a phase change recording layer of the medium to a first data recorded state, second data recorded state, and data non-recorded state, and an additional recording control unit configured to control additional recording of target data in response to an additional recording instruction by recording the target data by changing the phase change recording layer to the first and second data recorded states and by changing the phase change recording layer to the data non-recorded state from the recording terminal end of the target data over a predetermined length using the light beams with different intensities emitted by the recording/erase unit.

### CROSS-REFERENCE TO RELATED APPLICATIONS

This application is based upon and claims the benefit of priority from the prior Japanese Patent Application No. 2002-347505, filed Nov. 29, 2002, the entire contents of which are incorporated herein by reference.

### BACKGROUND OF THE INVENTION

1. Field of the Invention

The present invention relates to a data recording apparatus and data recording method for recording data on an additionally recordable storage medium, especially, a DVD-RW.

2. Description of the Related Art

In recent years, write-once optical discs such as a DVD-R, CD-R, and the like, and rewritable optical discs such as a DVD-RW, CD-RW, and the like have prevailed. A drive device can additionally record data on these optical discs in an additional recording mode. An additional recording mode for an optical disc such as a DVD is called an Incremental Recording Mode, and that for an optical disc such as a CD is called a Packet Write Mode. When a drive device receives an optical disc on which data was additionally recorded in the additional recording mode, and is to additionally record another data in the additional recording mode, a boundary point between the already recorded area and non-recorded area must be accurately searched for. An address indicating the found boundary point, i.e., NWA (Next Writeable Address information) is sent to a host computer.

In case of a write-once optical disc such as a DVD-R, CD-R, or the like, it is relatively easy to search for the boundary point between the already recorded area and non-recorded area, and it is possible to accurately search for that boundary point. Even in a rewritable optical disc such as a DVD-RW, CD-RW, or the like, if it is a disc (Full Blank Disc) from which data have been physically erased over the entire surface, it is relatively easy to search for the boundary point between the already recorded area and non-recorded area, and it is possible to accurately search for that boundary point.

On the other hand, in case of a rewritable optical disc such as a DVD-RW, CD-RW, or the like, a method of initializing the already data recorded disc to a blank state includes the following two methods:

1. Full Blank Mode: All recorded data are physically erased over the entire surface of a disc.

2. Minimally Blank Mode: This mode is a quick mode that erases only specific information (Track/Rzone information and information in a Lead-in area) on the inner peripheral portion of a disc. A data area on the disc is not erased in practice. That is, this mode is a logical erase mode.

The minimally blank mode is superior to the full blank mode since it can initialize a disc to a blank state in a very short period. However, in the minimally blank mode, only the specific information (Track/Rzone information and information in a Lead-in area) on the inner peripheral portion of a disc is erased, and the disc is merely logically set in a blank state. That is, data on the user area of the disc remain recorded.

The recording sizes of discs that have been processed in such minimally blank mode are all different depending on the use states before they are set in a blank state. Also, a plurality of boundary points between the already recorded areas and non-recorded areas are often present. For this reason, the NWA cannot often be accurately detected by accurately searching for the boundary point between the already recorded area and non-recorded areas.

In order to avoid such situation, it is practically impossible to record data on a disc, which has been processed in the minimally blank mode, in the additionally recording mode. When recording is made in the additionally recording mode anyway, full-surface erasure in the full blank mode is required in place of the minimally blank mode.

As a prior art, the following technique is disclosed in Jpn. Pat. Appln. KOKAI Publication No. 2000-30369. That is, upon writing data by segmenting a track of an optical disc into a plurality of packets, a predetermined number of erase blocks are written after the last block of the last packet in which data is written, and a packet in which blocks next to the last block are a predetermined number of erase blocks is recognized as the last packet of the track.

However, in case of a DVD-RW, even when erase blocks are written, as described above, data in the erase blocks and user data may be hardly distinguished from each other. As a result, the boundary point between the already recorded area and non-recorded area cannot be accurately detected.

### BRIEF SUMMARY OF THE INVENTION

A data recording apparatus according to one aspect of the present invention comprises a recording/erase unit configured to record or erase target data by irradiating a DVD-RW medium with light beams with different intensities to change a phase change recording layer of the medium to a first data recorded state, second data recorded state, and data non-recorded state, and an additional recording control unit configured to control additional recording of target data in response to an additional recording instruction by recording the target data by changing the phase change recording layer to the first and second data recorded states and by changing the phase change recording layer to the data non-recorded state from a recording terminal end of the target data over a predetermined length using the light beams with different intensities emitted by the recording/erase unit.

According to one aspect of the present invention, a data recording method for additionally recording target data on a DVD-RW medium in response to an additional recording instruction, comprises: recording target data by irradiating the medium with light beams with different intensities to change a phase change recording layer of the medium to a first data recorded state and second data recorded state; and changing the phase change recording layer to a data non-recorded state by irradiating the medium with a light beam of a predetermined intensity from a recording terminal end of the target data over a predetermined length.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows an example of the data recording state on a disc when data is additionally recorded on a rewritable disc such as a DVD-RW or the like by a data recording apparatus of the present invention;

FIG. 2 shows an example of the data recording state on a disc when another data is additionally recorded on the disc shown in FIG. 1 by the data recording apparatus of the present invention;

FIG. 3 is a view for explaining an example of a process for searching for a blank area upon additionally recording another data on the disc on which data has been additionally recorded by the data recording apparatus of the present invention;

FIG. 4 is a schematic block diagram showing the arrangement of a data recording apparatus according to an embodiment of the present invention; and

FIG. 5 is a flow chart for explaining a data recording method (additional recording control) according to an embodiment of the present invention.

### DETAILED DESCRIPTION OF THE INVENTION

An embodiment of the present invention will be described hereinafter with reference to the accompanying drawings.

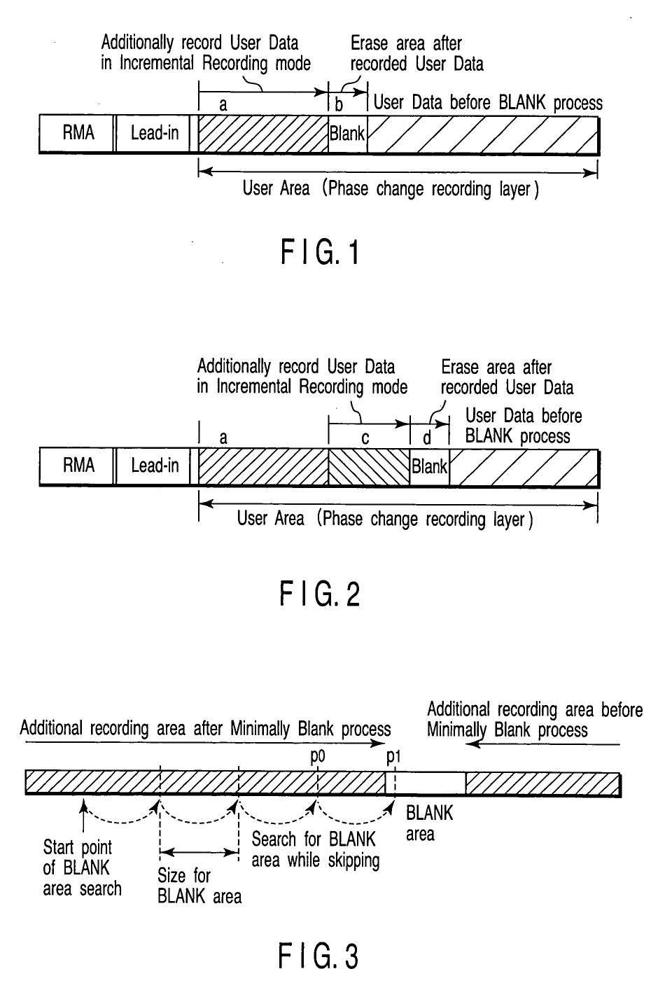

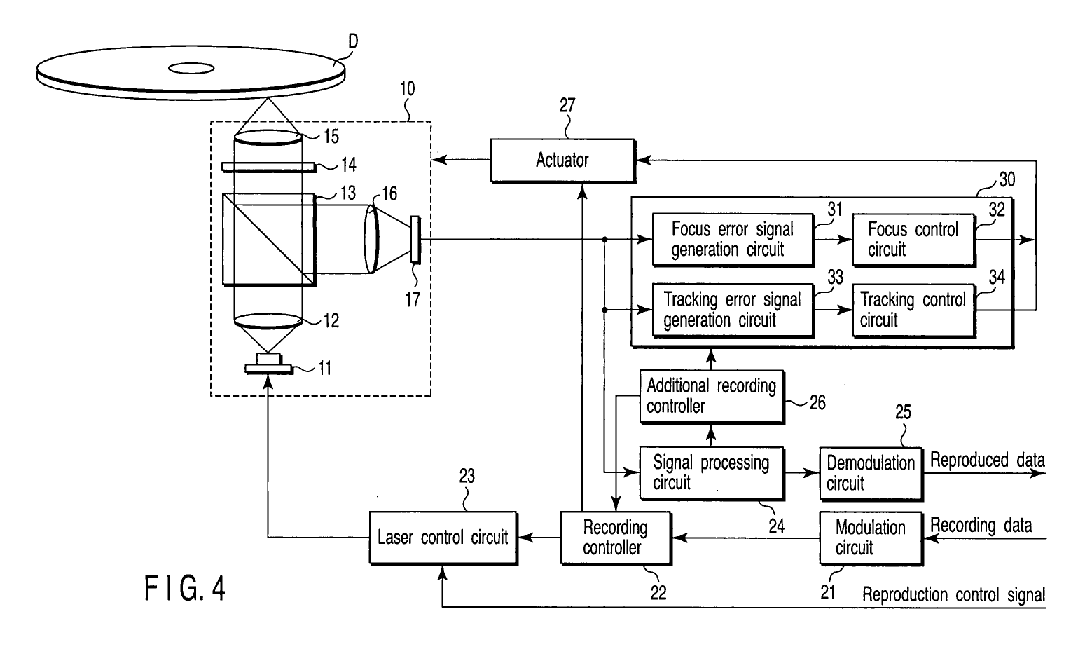

An additional recording process will be described below with reference to FIGS. 1 to 3. FIG. 1 shows the data recording state on a disc when data is additionally recorded on a rewritable disc such as a DVD-RW or the like by a data recording apparatus shown in FIG. 4. FIG. 2 shows the data recording state on a disc when another data is additionally recorded on the disc shown in FIG. 1 by the data recording apparatus shown in FIG. 4. FIG. 3 is a view for explaining a process for searching for a blank area upon additionally recording another data on the disc on which data has been additionally recorded by the data recording apparatus shown in FIG. 4.

As shown in FIG. 1, a DVD-RW disc comprises an RMA (Recordable Management Area), Lead-in area, and user data area (the phase change recording layer). More specifically, the RMA is allocated on the innermost periphery of the disc, and the Lead-in area is allocated outside the RMA. The user data area is allocated outside the Lead-in area.

The RMA records management/identification information, and includes an area called an RMD which records Rzone information. The Lead-in area is assured to maintain reproduction compatibility to a DVD-ROM disc. The user data area records actual user data.

When the DVD-RW disc undergoes an erase process in the full blank mode, a partial area in the RMA, the full Lead-in area, and the full user data area are erased. When the DVD-RW disc undergoes an erase process in the minimally blank mode, a partial area of the RMA and the full Lead-in area are erased in practice, but the user data area remains unerased.

As shown in FIG. 1, when data is recorded on the DVD-RW disc in the incremental recording mode, user data is recorded on area a designated by a write command from a host, and area b with a predetermined length after the last portion of area a is erased. That is, the DVD-RW disc is irradiated with light beams (blank state).

Next, when the host issues a new incremental recording write command, user data is additionally recorded from one end of area b toward the other end of area b, and area d with a predetermined length is erased after the recording end point of the user data. That is, as shown in FIG. 2, user data is recorded on area c that follows area a, and area d with a predetermined length is allocated after area c. Data “1” or “0” are recorded on area c, and area d is set in a data non-recorded state (blank state).

As described above, a DVD-RW is erased by a Physical ERASE process, and the erased area is set in a data non-recorded state (blank state). By contrast, a CD-RW is erased by recording a specific ERASE pattern. The specific ERASE pattern used in the erase process for the CD-RW can be present as user data of the DVD-RW. For this reason, the DVD-RW cannot be erased using such specific ERASE pattern. This is because the specific ERASE pattern may be confused as actual data (user data).

As described above, every time user data is additionally recorded on the DVD-RW, an area with a predetermined length is erased from the tail end of the user data recorded area. That is, an area with a predetermined length from the tail end of the user data recorded area is set in a data non-recorded state (blank state). In this manner, the head of a data non-recorded area (blank area) which is present at the innermost side of the disc is always defined as the boundary point between the already recorded area and non-recorded area. Hence, by searching for the data non-recorded area (blank area) which is present at the innermost side, the NWA can be accurately detected.

A method of searching for the boundary point between the already recorded area and non-recorded area from the disc that has undergone the additional recording process shown in FIGS. 1 and 2 will be described below with reference to FIG. 3. A data non-recorded area (blank area) is searched for in increments of predetermined length to have the head on the innermost periphery of the user data area as a start point. That is, a data non-recorded area (blank area) is searched for while skipping in increments of data non-recorded area (blank area). By maintaining (data non-recorded area with predetermined length)≧(skip interval upon search), a data non-recorded area (blank area) can be efficiently searched for without missing. If the previous NWA is held, a data non-recorded area (blank area) may be searched for in increments of predetermined length toward the outer periphery side.

Upon detection of a data non-recorded area (blank area), a binary search is made between a search point (P1) at which the data non-recorded area (blank area) is detected, and an immediately preceding search point (P0), thus identifying a boundary point between the already recorded area and non-recorded area. In this way, the boundary point can be identified within a short period of time.

A schematic arrangement of an optical disc apparatus (data recording apparatus) according to an embodiment of the present invention will be described below with reference to FIG. 4. This optical disc apparatus records information on an optical disc D such as a CD-R, CD-RW, DVD-R, DVD-RW, DVD-RAM, or the like, and reproduces data recorded on such optical disc D.

As shown in FIG. 4, the optical disc apparatus comprises an optical pickup 10, modulation circuit 21, recording controller 22, laser control circuit 23, signal processing circuit 24, demodulation circuit 25, additional recording controller 26, actuator 27, and focus tracking controller 30.

The optical pickup 10 comprises a laser 11, collimator lens 12, polarization beam splitter (to be referred to as a PBS hereinafter) 13, quarter wave plate 14, objective lens 15, focusing lens 16, and photodetector 17.

The focus tracking controller 30 comprises a focus error signal generation circuit 31, focus control circuit 32, tracking error signal generation circuit 33, and tracking control circuit 34.

An information recording process on the optical disc D by the optical disc apparatus will be explained below. A general recording process will be described first, and an additional recording process will then be described. The modulation circuit 21 modulates recording information (data symbol) provided from a host to a predetermined channel bit sequence in accordance with a predetermined modulation scheme. The channel bit sequence corresponding to the recording information is input to the recording controller 22. The recording controller 22 outputs a control signal to the actuator 27, and drives the optical pickup to appropriately focus a light beam at a target recording position. Furthermore, the recording controller 22 supplies the channel bit sequence to the laser control circuit 23. The laser control circuit 23 converts the channel bit sequence into a laser drive waveform, and drives the laser 11. That is, the laser control circuit 23 pulse-drives the laser 11. With this control, the laser 11 emits a recording light beam corresponding to a desired bit sequence. For example, the laser 11 emits light beams of different intensities in correspondence with channel bit sequences “1” and “0”. The recording light beam emitted by the laser 11 is converted into collimated light by the collimator lens 12. The collimated light enters and is transmitted through the PBS 13. The beam transmitted through the PBS 13 passes through the quarter wave plate 14, and is focused by the objective lens 15 on the information recording surface of the optical disc D. The focused beam is maintained in a state wherein it can form a best small spot on the recording surface, under the focus control of the focus control circuit 32 and actuator 27, and the tracking control of the tracking control circuit 34 and actuator 27. For example, the recording surface of a DVD-RW medium is formed of a phase change recording layer, which changes to a first data recording state (e.g., a recorded state of “0”) and a second data recording state (e.g., a recorded state of “1”) by the small spot that strikes the recording surface, thus recording target data.

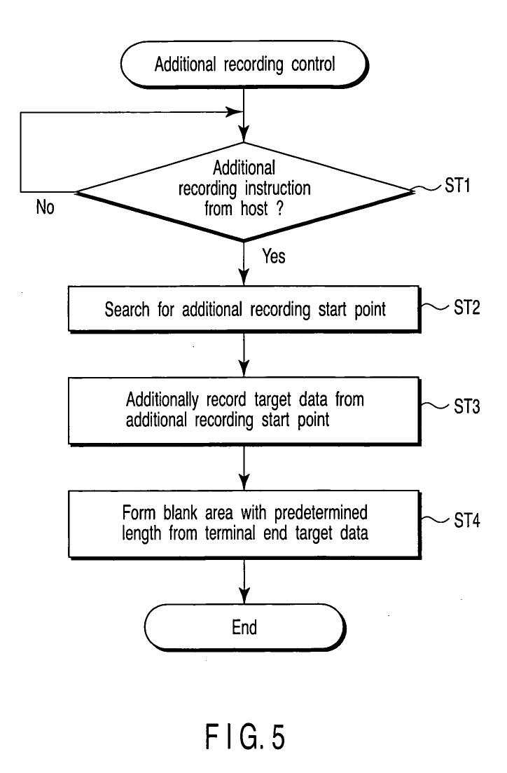

Upon reception of an additional recording instruction from the host, the additional recording controller 26 executes additional recording control. FIG. 5 is a flow chart showing the flow of the additional recording control. More specifically, as shown in FIG. 5, the additional recording controller 26 searches for an additional recording start point (ST2) in response to the additional recording instruction from the host (ST1, YES). That is, the additional recording controller 26 instructs the focus tracking controller 30 to search for an additional recording start point, and detects a data non-recorded area (blank area) by monitoring an output from the signal processing circuit 24. Subsequently, the additional recording controller 26 identifies a boundary point between the already recorded area and non-recorded area by the aforementioned binary search. This boundary point is the additional recording start point. The additional recording controller 26 issues a recording permission instruction to the recording controller 22 to control it to additionally record target data from the additional recording start point (ST3). Upon completion of additional recording of the target data, the additional recording controller 26 instructs the recording controller 22 to allocate a data non-recording area (blank area), so as to form a data non-recording area (blank area) on an area having a predetermined length from the recording terminal end of the target data (ST4).

Next, a data reproduction process from the optical disc D by the optical disc apparatus will be described below. The laser control circuit 23 drives the laser 11 on the basis of a reproduction control signal. With this drive control, the laser 11 emits a reproduction light beam. The reproduction light beam emitted by the laser 11 is converted into collimated light by the collimator lens 12. The collimated light enters and is transmitted through the PBS 13. The light beam transmitted through the PBS 13 passes through the quarter wave plate 14, and is focused by the objective lens 15 on the information recording surface of the optical disc D. The focused reproduction light beam is maintained in a state wherein it can form a best small spot on the recording surface, under the focus control of the focus control circuit 32 and actuator 27, and the tracking control of the tracking control circuit 34 and actuator 27. At this time, the reproduction light beam that strikes the optical disc D is reflected by a reflection film or reflective recording film in the information recording surface. The reflected light is transmitted through the objective lens 15 in the reverse direction, and is converted into collimated light again. The reflected light is transmitted through the quarter wave plate 14, and is reflected by the PBS 13 since it has a plane of polarization perpendicular to the incoming light. The beam reflected by the PBS 13 is converted into convergent light by the focusing lens 16, and enters the photodetector 17. The photodetector 17 comprises, e.g., a 4-split photodetector. The light beam that has entered the photodetector 17 is photoelectrically converted into an electrical signal, which is then amplified. The amplified signal is equalized and binarized by the signal processing circuit 24, and is then supplied to the demodulation circuit 25. The signal undergoes demodulation corresponding to a predetermined modulation method in the demodulation circuit 25, thus outputting reproduction data.

The focus error signal generation circuit 31 generates a focus error signal on the basis of some components of the electrical signal output from the photodetector 17. Likewise, the tracking error signal generation circuit 33 generates a tracking error signal on the basis of some components of the electrical signal output from the photodetector 17. The focus control circuit 32 controls the actuator 27 to control focusing of a beam spot on the basis of the focus error signal. The tracking control circuit 34 controls the actuator 27 to control tracking of a beam spot on the basis of the tracking error signal.

As described above, according to the present invention, target data can be additionally recorded on a disc, which is logically set in a blank state in the minimally blank mode, so as to allow an accurate NWA search.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data recording apparatus comprising:
a recording/erase unit configured to record or erase target data by irradiating a DVD-RW medium with light beams with different intensities to change a phase change recording layer of the medium to a first data recorded state, second data recorded state, and data non-recorded state; and
an additional recording control unit configured to control additional recording of target data in response to an additional recording instruction by recording the target data by changing the phase change recording layer to the first and second data recorded states and by changing the phase change recording layer to the data non-recorded state from a recording terminal end of the target data over a predetermined length using the light beams with different intensities emitted by the recording/erase unit.

2. An apparatus according to claim 1, wherein the additional recording control unit searches for an area in the data non-recorded state with the predetermined length in response to the additional recording instruction, and records the target data from one end to the other end of the found area.

3. An apparatus according to claim 1, wherein the additional recording control unit searches for an area in the data non-recorded state with the predetermined length, which is present on an innermost periphery side in a data recording area of the medium, in response to the additional recording instruction, and records the target data from one end to the other end of the found area.

4. An apparatus according to claim 1, wherein the additional recording control unit searches for an area in the data non-recorded state with the predetermined length, which is present on an innermost periphery side in a data recording area of the medium, by skipping in increments of predetermined length from a start point on the innermost periphery side of the data recording area of the medium in response to the additional recording instruction, and records the target data from one end to the other end of the found area.

5. A data recording method for additionally recording target data on a DVD-RW medium in response to an additional recording instruction, comprising:
recording target data by irradiating the medium with light beams with different intensities to change a phase change recording layer of the medium to a first data recorded state and second data recorded state; and
changing the phase change recording layer to a data non-recorded state by irradiating the medium with a light beam of a predetermined intensity from a recording terminal end of the target data over a predetermined length.

6. A method according to claim 5, wherein an area in the data non-recorded state with the predetermined length is searched for in response to the additional recording instruction, and the target data is recorded from one end to the other end of the found area.

7. A method according to claim 5, wherein an area in the data non-recorded state with the predetermined length, which is present on an innermost periphery side in a data recording area of the medium, is searched for in response to the additional recording instruction, and the target data is recorded from one end to the other end of the found area.

8. A method according to claim 5, wherein an area in the data non-recorded state with the predetermined length, which is present on an innermost periphery side in a data recording area of the medium, is searched for by skipping in increments of predetermined length from a start point on the innermost periphery side of the data recording area of the medium in response to the additional recording instruction, and the target data is recorded from one end to the other end of the found area.

9. A DVD-RW medium comprising a phase change recording layer,
wherein the phase change recording layer is changed to a first data recorded state, second data recorded state, and data non-recorded state upon being irradiated with light beams with different intensities, and
the phase change recording layer records target data when the phase change recording layer is changed to the first and second data recorded states, and the phase change recording layer is changed to the data non-recorded state over a predetermined length from a recording terminal end of the target data, upon being irradiated with the light beams with different intensities corresponding to additional recording control of the target data.

10. A medium according to claim 9, wherein the target data is recorded from one end to the other end of an area in the data non-recorded state with the predetermined length, which is found by a search from the phase change recording layer, in correspondence with additional recording control of the target data.

11. A medium according to claim 9, wherein the target data is recorded from one end to the other end of an area in the data non-recorded state with the predetermined length, which is found by a search from the phase change recording layer and is present on an innermost periphery side, in correspondence with additional recording control of the target data.

12. A medium according to claim 9, wherein the target data is recorded from one end to the other end of an area in the data non-recorded state with the predetermined length, which is found by a search by skipping in increments of predetermined length from a start point on an innermost periphery side of the phase change recording layer and is present on the innermost periphery side, in correspondence with additional recording control of the target data.
